(19) United States
(12) Patent Application Publication
(10) Pub. No.: US 2007/0220086 A1
(43) Pub. Date: Sep. 20, 2007

(54) Record access document retrieval system and method

(75) Inventors: Robert Goldberg, New York, NY (US); John Bowen, Kingston, NY (US)

Correspondence Address: OSTROLENK FABER GERB & SOFFEN, 1180 AVENUE OF THE AMERICAS, NEW YORK, NY, 100368403, US

(73) Assignee: Record Access Corporation

(21) Appl. No.: 11/378,971

(22) Filed: Mar. 17, 2006

(51) Int. Cl. G06F 15/16

(52) U.S. Cl. 709/203; 709/217

(57) ABSTRACT

The present invention relates to a system and method for facilitating requests for health information related to at least one party in a lawsuit. The invention includes a user interface that enables users to requesting and receiving health information request forms, to enter and viewing the information regarding the request, to enter and view status information regarding a request, to enter and view information regarding the lawsuit information, and to enter and view health information. The information is provided and received as a function of the user interface over a communication network such that requests for health information can be facilitated.

### FIELD OF THE INVENTION

The present invention relates generally to communication, and, more particularly, to a centrally managed process and system for the production, reception and distribution of electronic information.

### BACKGROUND OF THE INVENTION

The need for production of documents and other information, such as related to medical records, during litigation is well-known. For example, law firms and insurance companies representing defendants in medical-related legal actions need to review various documents, including medical records and reports to properly prepare for and defend a legal case. In a typical prior art scenario, documents are retrieved in paper format, photocopied and then dispatched to requesting parties, e.g., insurance companies and law firms. Photocopies of documents may also be sent to adjusters and expert witnesses.

The volume of paper generated in a document production for a medical-related lawsuit is expensive and time-consuming. The costs in terms of time and money related to accessing, organizing, reproducing, storing and delivering the documents can be very large. Managing the documents, including receiving a single document and providing multiple copies thereof to a plurality of parties is inefficient and increases costs. Also, documents may be inefficiently organized, stored and distributed.

Moreover, a specialist (i.e., paid personnel, such as a paralegal or other legal staff) may be required to manage document production during a lawsuit. In the prior art, a specialist manages requests for documents, retrieving and reproducing the documents, and delivering the documents from/to law firms, insurance companies, physician offices, or the like.

In an effort to overcome problems associated with document production, for example, in a medical-related lawsuit, parties have sought to distribute and receive materials in electronic form. It was believed that electronic distribution of documents would increase efficiency by alleviating delays and costs associated with physical document production. Unfortunately, distributing electronic documents, particularly related to medical healthcare, has not mitigated delays and costs associated with document production and management. This is partly because healthcare information in electronic form is believed to be much less secure than in paper form and, accordingly, laws have been implemented to address policy concerns related to distributing electronic healthcare information and to protect patient privacy and security.

One example of legal standards related to the distribution of electronic healthcare information is the Health Insurance Portability and Accountability Act (“HIPAA” ). In short, HIPAA is a federal law that addresses the availability, portability and efficiency of health coverage and related information. Restrictions and rules defined in HIPAA were designed, in part, to safeguard patient privacy and security. One aspect of HIPAA relates to protected electronic health information generated by health plans, health care clearinghouses, and certain health care providers. The rules in the Act have been developed to improve the effectiveness and efficiency of the health care industry, in general, by establishing a level of patient protection for certain electronic health information.

Unfortunately, HIPAA (and other legal) regulations may adversely impact the amount of time and money that parties who request and provide health-related electronic information incur. Formal requirements, including those related to requesting electronic health information and ensuring that adequate security measures are implemented, have negatively impacted the time and costs associated with electronic health care information distribution. Moreover, the manner of requesting and sharing electronic health information is regulated to the point that many requests for information are denied. Any request for electronic medical information that does not comply with the multitude of requirements related to patient privacy and security can be denied.

In addition to the denial of requests due to non-compliance with regulations, other problems associated with document production exist in the prior art that negatively impact time and costs. In many cases, defendant(s) do not have access to up-to-date or accurate information relating to health care providers, such as names, addresses, telephone numbers or the like. Valuable resources, including time and capital, are often wasted trying to obtain accurate and current information of a party who in some cases is the sole source of information. Thus, another delay in receiving requested health care information is caused by inaccurate contact information.

Moreover, a properly formatted request for healthcare information that is transmitted to and received by the proper party does not ensure timely and cost-effective results. Many requests for electronic healthcare information go unanswered for months. A party managing the document productions in several large lawsuits can easily lose time tracking those requests that go unanswered for periods of time. Thus, another problem in the prior art that negatively impacts costs and time relates to regular and frequent follow-ups to requests.

Thus, even though healthcare information is requested and received in electronic form, problems associated with cost and time are not necessarily alleviated.

### SUMMARY OF THE INVENTION

The present invention relates to a system and method for facilitating requests for information, such as health information, related to at least one party in a lawsuit. Preferably, the invention comprises providing on an information processor an information request form, such that the form is usable to request information and further wherein the form complies with at least one regulation. Further, a service provider module is provided that is operable to store on the information processor information relating to a service provider, such as a healthcare provider.

Moreover, the invention comprises a lawsuit module that is operable to store on the information processor information relating to the lawsuit. Also, a request module operable to store on the information processor request information that relates to requests for information. An information module is also provided and operable to store electronic information that is received in response to the request for information. Also, a user interface is provided that enables a user to perform at least one of several tasks. For example, the user interface enables a user to request and receive the request form, as well as to enter and view the request information. Also, the user interface enables the entering and viewing status information regarding the information request. Furthermore, the interface enables a user to enter and view the lawsuit information, as well as to enter and view the information.

Furthermore, the various modules of the present invention are operable to receive information as a function of the user interface over a communication network, such that requests for health information can be facilitated.

Other features and advantages of the present invention will become apparent from the following description of the invention, which refers to the accompanying drawings.

### BRIEF DESCRIPTION OF THE DRAWINGS

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 shows an example hardware arrangement in a preferred embodiment of the present invention;

FIG. 2 indicates the functional elements of a user terminal and/or information processor;

FIG. 3 is a block diagram that illustrates an example networked arrangement of parties associated with the present invention;

FIG. 4 is a block diagram illustrating options that are provided to an authorized user in accordance with a preferred embodiment of the present invention;

FIGS. 5A-5C illustrate a data entry form that is preferably displayed and associated with entering a new case into a database via an internet-based data entry form;

FIG. 6 shows an example display screen that is presented after an option for reviewing recently completed requests is selected by a user;

FIG. 7A displays an example request overview display screen in accordance with a preferred embodiment of the present invention;

FIG. 7B illustrates an example display screen that provides a medical-related document requested by a user of the present invention;

FIG. 7C shows an example HIPAA compliant authorization request form provided in accordance with a preferred embodiment of the present invention;

FIG. 8 is an example case summary display screen provided in accordance with a preferred embodiment;

FIG. 9 is an example display screen that is preferably presented to a user after a respective action required report is selected;

FIG. 10 illustrates an example display screen that is preferably provided to users requesting electronic medical information;

FIG. 11 is an example data entry display screen for adding a new user to access to the internet web site provided in a preferred embodiment; and

FIG. 12 is an example data entry display form for enabling an expert witness to have access to records provided in accordance with the present invention.

### DETAILED DESCRIPTION OF THE PREFERRED EMBODIMENTS

The present invention includes a system and method that is operable to remove impediments related to obtaining records, such as medical records, quickly and accurately. In a preferred embodiment, the present invention centrally facilitates the processing and fulfillment of requests for information from various providers in a timely and efficient manner. For example, the invention enables parties in a medical-related lawsuit to request medical records, to receive the records and to reproduce the records easily and quickly. The invention provides an integrated interface that enables users to request documents and medical records, and the invention further enables the fulfillment of such requests securely and efficiently.

In a preferred embodiment, the present invention is a centrally managed system that enables a secure, bi-directional communication flow of sensitive information between a plurality of parties. A plurality of parties that are associated with one or more medical-related lawsuits and who either require information related to the lawsuit(s), or, alternatively, provide information related to the lawsuit(s) use the present invention accordingly. For example, a hospital provides medical care to a plaintiff, and maintains medical records regarding the plaintiff. The hospital's records may be requested by a defendant physician, or other defendant who is a party to the lawsuit. In one embodiment, the invention includes receiving paper copies of medical information, and digitizing materials (i.e., by scanning) to ensure timely and reliable distribution, as well as to provide efficient storage thereof.

Using the centrally managed system of the present invention, requests for documents (e.g., records related to medical care provided to a plaintiff) are properly formatted in accordance with various HIPAA and/or other regulations. As noted above, formatting requests to be compliant with HIPAA, particularly requests for electronic information, requires a detailed and proficient knowledge of regulatory rules that are often difficult to understand and follow. Failing to comply with HIPAA rules often results in denials and costly delays, which adversely affects parties seeking to secure information.

In an embodiment, a database is provided that includes forms to be used to request documents and information, for example, related to a person's medical information. Users of the present invention may submit a copy of a preferred form which can be later retrieved from the database and used to request, for example, medical information. In one embodiment, the forms arrive in paper format, and a data entry person reproduces the form by typing it into a word processor. The electronic version of the form is, thereafter, stored in a database and available for future use. In another embodiment, a form is scanned, converted to another format (such as an ADOBE ACROBAT PORTABLE DOCUMENT FORMAT “PDF” file), and then modified such that a user can enter information directly into the form for use in requesting medical healthcare information.

In some cases, a form may need to be executed by a particular patient or authorized representative, and then submitted to the appropriate party via the present invention. One feature of the present invention is that the progress of fulfilling a document request can be tracked in an interactive user interface (described below). Another feature of the invention is that an electronic copy of the document or other record can be viewed via the user interface. Using these features, the progress of a request can be monitored, and, once a document is available, users can view documents electronically without the delays typically associated with copying and shipping physical materials.

By utilizing electronic versions of documents and employing a database via a internet web-based user interface, the invention capitalizes on opportunities directed to improving efficiency and reducing costs. For example, problems associated with interruptions or breakdowns in communication can be prevented.

Once documents have been received and stored in an information processor, users can locate the documents using a plurality of search criteria, such as file number, patient name,.date or other values. When a document is located, users can preferably view the documents electronically, print the document or order a copy of the document on CD/DVD. Users can also order a physical copy of a document. Documents preferably remain available to a user in electronic format until a user elects to archive a case, until expiration of a time period defined by the proprietor or authorized user of the present invention.

The present invention further regularly follows up requests for electronic information to ensure that the information is received and delivered. In case of a denial to a request, reasons for the denial are quickly pursued and, when possible, remedied. This is accomplished by a tracking system, referred to herein as a tickler, that monitors dates to ensure that requests are not forgotten or ignored. Thus, requesting parties, such as law firms representing defendants and who are authorized by the proprietor of the present invention, are provided the materials in a timely and cost effective manner. The present invention dramatically improves upon prior art methods to ensure that requests for electronic information are met.

The present invention preferably facilitates properly formatted requests for materials, such as documents directed to discovery in a medical-related lawsuit, to ensure compliance with various regulations, such as in HIPAA. Preferably, an archive of pre-formatted documents can be accessed from a secured internet web site and used for requesting materials. Various embodiments are provided herein. For example (as noted above), the pre-formatted documents may be ADOBE PDF files that are formatted to accept alphanumeric information in one or more data entry fields. In another embodiment, users print the pre-formatted documents and add information on a hard copy (i.e., printed copy) of the document. In yet another alternative, users independently recreate the pre-formatted documents, such as by using word processor software, and effectively use a pre-formatted document as a template.

As note above, failure to comply with technical regulations, including relating to the formatting of requests for electronic health information, can result in costly delays. The present invention reduces the chances that requests for information, including information related to medical healthcare are not denied for failing to comply with proper formatting requirements.

Also in a preferred embodiment, the present invention comprises a secure, on-line computer software application that supports the retrieval and distribution of information, for example, typically sought in medical-related lawsuits. The application is easy to learn and use, is robust, secure and customizable for each of a plurality of entities and users. The present invention includes data management and data retrieval, and utilizes executable computer code for performing the functions described herein. For example, user-interfaces are presented that enable user-queries to be executed quickly. The invention further provides a robust security infrastructure without degrading operation performance. Moreover, the application is preferably adaptable to support changes in the future, as needed.

Although many of the descriptions and examples used herein refer to defendants and/or medical-related lawsuits, the present invention is not so limited. The present invention may be used in any context in which information, such as documents and/or records, are requested and delivered to parties with various needs.

The present invention preferably maintains comprehensive lists of service providers, medical healthcare providers or other parties that provide information for defendants in medical-related lawsuits. Preferably, the lists are regularly and/or frequently maintained and/or updated in order to ensure that current and accurate information regarding service providers, medical caregivers or the like is available. For example, service providers, medical healthcare providers or other parties are regularly reviewed and/or contacted and, if necessary, change of address information, telephone number listings or the like are updated. Further, information regarding such parties are preferably annotated so users can provide additional information corresponding to an entry in the list.

Thus, the present invention accommodates a plurality of parties that interact with a proprietor of the present invention in a variety of contexts. A feature of the invention is that the integrity of information, particularly with respect to the many contexts in which users interact, is maintained. For example, each respective law firm preferably receives data regarding its respective client(s). Also, a plurality of defendants in a medical-related lawsuit may have a single insurer and a plurality of attorneys. Proper and specific authorization is provided for each party in accordance with the teachings herein. In a preferred embodiment, a plurality of parties, for example requesting information and/or documentation related to one or more medical-related lawsuits, each receive respective information that is requested. Moreover, access to electronic information is preferably limited to particular parties. In case, for example, two related medical-related lawsuits are pending, a substantial amount of data (typically in the form of medical records and reports) is received by the present invention and the data are managed such that information is correctly provided to each authorized requestor for each respective lawsuit.

The present invention is preferably implemented via an internet web site. For example, insurance companies, law firms, expert witnesses and various parties functioning in an administrative capacity may interact with the present invention, preferably via computer workstations equipped with standard web browsing software applications. In accordance with the teachings herein, various parties use the present invention to perform actions, typically related to obtaining or disbursing information, such as medical documents and records. A plurality of users establish communication sessions with a central provider, such as a computer server, to identify requests and/or actions that are pending related, for example, to a medical-related lawsuit. In this way, various requests and/or actions that are performed in can be monitored and managed, for example, during the course of a lawsuit.

Preferably, the present invention provides substantial reductions in costs associated with document and information distribution. By distributing electronic documents to various parties, for example, to one or more medical-related lawsuits, information is rapidly disseminated and costs are reduced for the recipients. For example, multiple defendants may be involved in a single lawsuit, each of which require copies of the same documents. Thus, in one embodiment of the present invention, various business methods are envisioned. For example, a reduced rate may be charged to parties who request information that has already been produced for that party, or another party. After initial fees have been received for receiving, digitizing documents and disseminating documents to an authorized requestor, the fees associated with disseminating the documents to another authorized requestor (or the same requestor) may be considerably less.

In addition to reducing rates associated with document and information production, the present invention provides substantial revenue opportunities particularly for the proprietor thereof. Preferably, the proprietor of the present invention charges a fee to parties for services provided, as described herein. Further, the paying parties receive a substantial savings over prior art document production methods. For example, third party administrators (e.g., insurance companies) and law firms pay the proprietor of the present invention a fee, and receive information faster and more securely than in the prior art. The proprietor realizes profit from the fees, particularly as the number of parties that interact with the proprietor increase.

In a preferred embodiment of the present invention, the present invention notifies parties that are identifying actions to be taken or assigned that all activity (or, alternatively specific activity) related to the matter is halted. For example, in the event that a lawsuit settles, the present invention prevents users from expending time and resources by notifying parties of the settlement. In a preferred embodiment, a user who attempts to perform or assign an activity related to a settled lawsuit is automatically prevented from doing so. For example, graphic screen controls in a user interface may become disabled, or a user may be automatically logged off of a data entry session. Preferably, some form of notification, such as a pop-up window display screen, is provided that indicates to the user that a lawsuit has settled or some other event has occurred, and that no further actions should be taken. In this way, users are informed of the current status of a lawsuit, and unnecessary activity that would otherwise result in wasted resources is prevented.

In a preferred embodiment, the present invention allows parties to upload electronic documents to a central location, thereby precluding the need to physically produce paper documents. During medical-related lawsuit document production, it is envisioned herein that security and safety standards, such as those related to HIPAA regulations, will be carefully and consistently enforced. Therefore, parties desiring to transmit electronic documents that contain sensitive information, such as medical records, comply with regulations before sending the electronic documents.

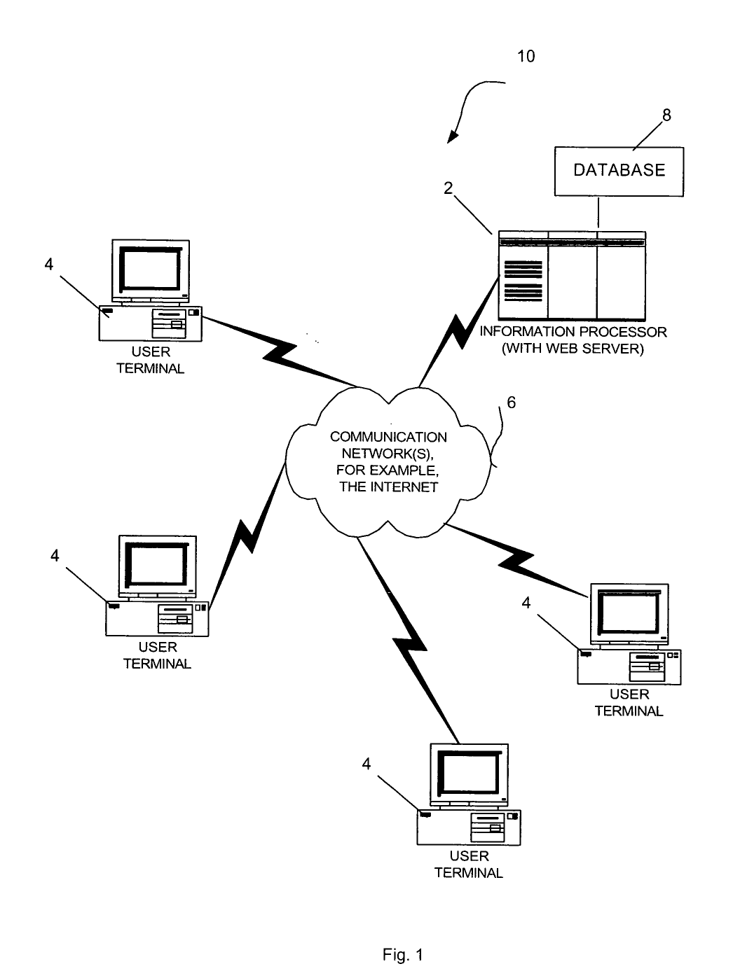

Referring to the drawings, in which like reference numerals refer to like elements, FIG. 1 shows an example hardware arrangement in a preferred embodiment of the present invention and referred to generally as system 10. In the embodiment shown in FIG. 1, system 10 comprises at least one information processor 2 configured to operate as an internet web server and that is operable to access and update a database 8. Information processor 2 preferably accesses communication network 6 and communicates with user terminals 4. Preferably, user terminals 4 and information processor 2 communicates via the known communications protocol, Transmission Control Protocol/Internet Protocol “TCP/IP.” In this way, content can be transmitted to and from the devices 2 and 4, and commands can be executed to enable the various functions described herein.

Information processors 2 and user terminals 4 are any devices that are capable of sending and receiving data across communication network 6, e.g., mainframe computers, mini computers, personal computers, laptop computers, a personal digital assistants (PDA) and internet access devices such as Web TV. In addition, information processors 2 and user terminals 4 are preferably equipped with a web browser, such as MICROSOFT INTERNET EXPLORER, NETSCAPE NAVIGATOR, MOZILLA FIRREFOX or the like. Thus, as envisioned herein, information processor 2 and/or user terminals 4 are devices that can communicate over a network and can be operated anywhere, including, for example, moving vehicles.

The nature of the present invention is such that one skilled in the art of writing computer executable code (i.e., software) can implement the described functions using one or more of a combination of popular computer programming languages and developing environments including, but not limited to C, C++, Visual Basic, JAVA, PHP, HTML, XML, ACTIVE SERVER PAGES, JAVA server pages, servlets, MICROSOFT .NET, and a plurality of various web site development applications.

For example, data may be configured in a MICROSOFT EXCEL spreadsheet file, as a comma delimited ASCII text file, as a MICROSOFT SQL SERVER compatible table file (e.g., MS-ACCESS table), or the like. In another embodiment, data may be formatted as an image file (e.g., TIFF, JPG, BMP, GIF, or the like). In yet another embodiment, data may be stored in an ADOBE ACROBAT PDF file. Preferably, one or more data formatting and/or normalization routines are provided that manage data received from one or a plurality of sources. In another example, data are received that are provided in a particular format (e.g., MICROSOFT EXCEL), and programming routines are executed that convert the data to another formatted (e.g., ASCII comma-delimited text).

It is contemplated herein that any suitable operating system can be used on user terminals 4 and information processor 2, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS, POCKET PC or any other suitable operating system. Of course, one skilled in the art will recognize that other software applications are available in accordance with the teachings herein, including, for example, via JAVA, JAVA Script, Action Script, Swish, or the like.

Moreover, a plurality of data file types is envisioned herein. For example, the present invention preferably supports various suitable multi-media file types, including (but not limited to) JPEG, BMP, GIF, TIFF, MPEG, AVI, SWF, RAW or the like (as known to those skilled in the art).

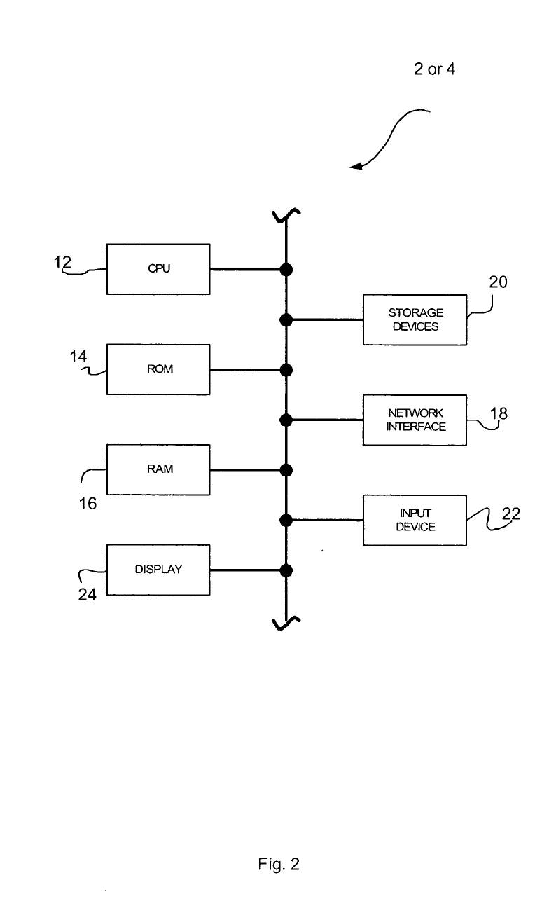

FIG. 2 illustrates the functional elements of user terminal 4 and/or information processor 2 and that include one or more central processing units (CPU) 12 used to execute software code and control the operation of user terminal 4 or information processor 2, read-only memory (ROM) 14, random access memory (RAM) 16, one or more network interfaces 18 to transmit and receive data to and from other computing devices across a communication network, storage devices 20 such as a hard disk drive, floppy disk drive, tape drive, CD ROM or DVD for storing program code, databases and application data, one or more input devices 22 such as a keyboard, mouse, track ball, magnetic card reading device, bar code reading device, microphone or the like, and a display 24.

The various components of information processor 2 and/or user terminal 4 need not be physically contained within the same chassis or even located in a single location. For example, storage device 20 may be located at a site which is remote from the remaining elements of information processor 2 or user terminal 4, and may even be connected to CPU 12 across communication network 6 via network interface 18. Information processor 2 preferably includes a memory equipped with sufficient storage to provide the necessary databases, forums, and other community services as well as acting as a web server for communicating hypertext markup language (HTML), FLASH, Action Script, Java, Active Server Pages, Active-X control programs on user terminals 4. Information processors 2 are arranged with components, for example, those shown in FIG. 2, suitable for the expected operating environment of information processor 2. The CPU(s) 12, network interface(s) 18 and memory and storage devices are selected to ensure that capacities are arranged to accommodate expected demand.

As used herein, the term, “module” refers, generally, to one or more discrete components that contribute to the effectiveness of the present invention. Modules can operate or, alternatively, depend upon one or more other modules in order to function.

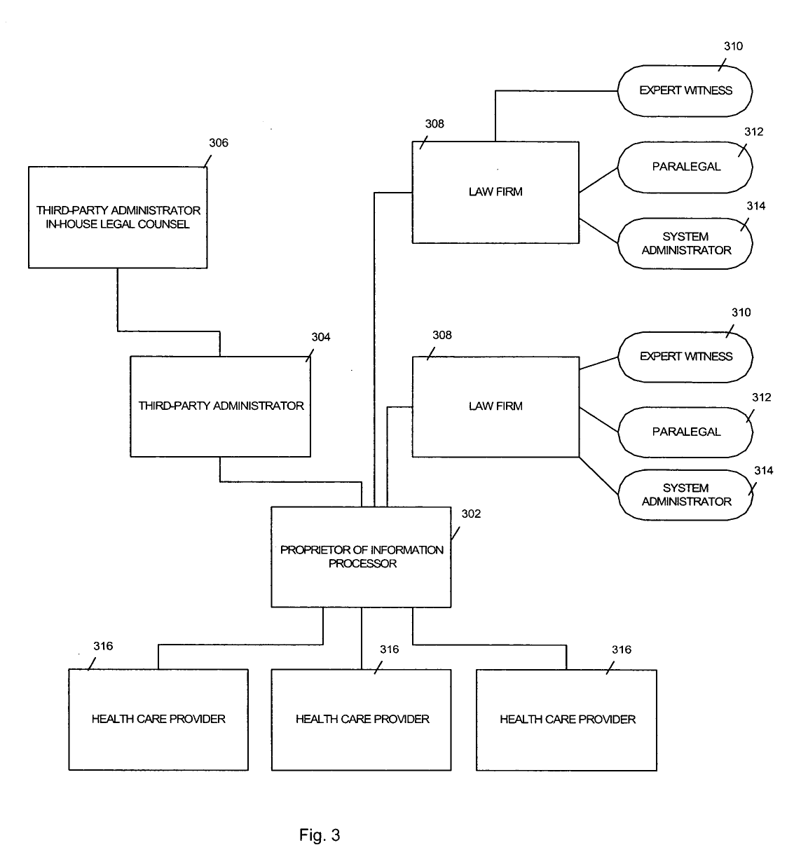

FIG. 3 is a block diagram that illustrates an example networked arrangement of parties associated with the present invention. As noted with reference to FIGS. 1 and 2, the present invention is operable over one or more communication networks, such as the internet, a wide area networks, a local area network or the like. Thus, the present invention allows various parties to communicate information to each other that is useful or necessary to execute the teachings herein. One skilled in the art will recognize that the internet enables the convenient and rapid exchange of information, thereby enabling parties to transmit information.

Continuing with reference to FIG. 3, proprietor of information processor 302 preferably implements many of the teachings provided herein. For example, proprietor 302 maintains information processor 2, thereby providing document access and ensuring that appropriate compliance with various rules associated with document requests and production, such as those established by HIPAA, is properly maintained and followed. The rules are preferably stored in database 8, for example, which, as noted above, is preferably maintained on information processor 2.

Third-party administrator 304 preferably provides claims administration, for example, related to health benefits for companies and/or individuals. In accordance with the present invention, third-party administrator 304, typically, is an insurance company representing a defendant in a medical-related lawsuit. For example, an individual may slip and fall on stairs under the control of a large retail establishment. The individual, injured by the slip and fall, sues the retailer for his injuries. Continuing with this example, the third-party administrator 304 represents the retailer and solicits the services of proprietor 302, among other things, to gain access to health-care records and information related to the plaintiff.

As shown in FIG. 3, third-party administrator 304 may have in-house legal counsel 306 that, accordingly, interfaces with proprietor 302 for health care information. Alternatively or in addition, independent law firms 308 interface with proprietor 302. In case of a lawsuit related to medical care, law firms 308 may be associated with the suit by independently representing one or more plaintiffs, one or more defendants, or may be hired by third-party administrator 304 to represent one or more defendants. Each law firm 308 may use expert witnesses 310 who typically require access to health information. Further, law firms 308 typically employ one or more paralegal workers 312 and system administrators 314, who may also interface with proprietor 302 in various contexts. For example, paralegal workers 312 may communicate with proprietor 302 to inquire of the status of a request or to assign an action to be taken in connection with a pending lawsuit. System administrator 314 may interface with proprietor 302 to ensure that users' access are provided and properly maintained.

In addition to attorneys, insurers and associated various parties interfacing with proprietor 302, it is envisioned herein that one or more health care providers 316 interface with proprietor 302 in various contexts. Example of health care providers 316 include hospitals, physicians, physician assistants, nurses, physical therapists, or the like. Preferably, various parties seeking access to health information (e.g., third-party administrators 304, law firms 308, expert witnesses 310, or the like) interface with proprietor 302 in order to request and receive such information.

Proprietor 302 provides various services associated with requesting and distributing electronic health information. For example, proprietor 302 ensures proper formatting of requests for health information in order to avoid such requests being denied on technical and/or legal grounds. Proprietor 302 receives requests for health information from submissions in web-based data entry form(s), and properly formats such requests in accordance with HIPAA standards. The properly formatted requests are preferably transmitted by proprietor 302 to healthcare provider(s) 316.

Another example of services provided by proprietor 302 is an assurance that requests for health information will be sent to correct parties and correct addresses. As noted above, lists of health care providers 316 are regularly and/or frequently updated to maintain current and accurate information. For example, a request for health information from a Dr. Smith at 100 Broadway is received by proprietor 302, and modified to be sent to the same Dr. Smith at 200 State Street. The modification of the request in this example represents Dr. Smith's change of address information, which was unknown to the requestor. Proprietor 302 reduces costly delays by properly formatting requests for information (e.g., to comply with HIPAA standards), and by maintaining current and accurate information.

In practice, parties to system 10, such as those illustrated in FIG. 3, interact with proprietor 302 via communication network 6 using an computerized system available over the internet. Preferably, an authorized user connects to an internet web site provided by proprietor 302 using standard web browser software, and submits a user name and password that allows information processor 2 to establish a secured communication session therewith. Once the secured session is established, the user, for example, third-party administrator 304, has access to a plurality of menu commands, graphical screen controls (e.g., icons, drop-down lists, checkboxes or the like) and data entry display screens that enable the user to request and/or receive information. For example, upon gaining secured access to information processor 2, the user is provided a series of options enabling, for example, reviewing materials, requesting information and managing access and administrative rights associated with other users.

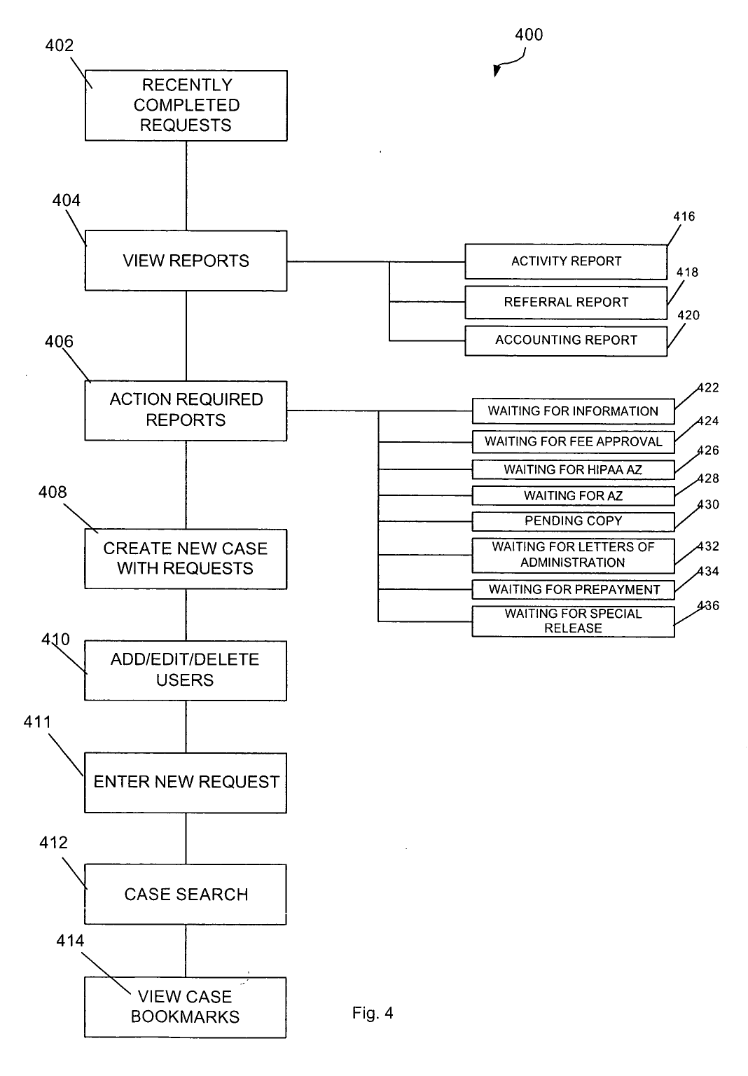

FIG. 4 is a block diagram illustrating an example embodiment of the present invention in which Options 400 are provided to an authorized user of the internet web site of proprietor 302. The order of the selections comprising Options 400 are in accordance with a preferred embodiment. For example, it is believed by the inventor that more often users select choices to review completed requests and monitor pending activities than do users opening new cases. Accordingly, selections directed to reviewing requests are placed more prominently (i.e., higher in the list) than are selections directed to adding a new case. Of course, one skilled in the art will recognize that the options depicted in FIG. 4 are illustrative, and that countless ways of providing selections therein, as well as choices with regard to graphical screen controls, screen displays and layouts are possible and may differ in various implementations.

Each of the selections in Options 400 are available for users have respective authorization. For example, a user that is authorized to determine whether a particular document request has been satisfied may not have the authority to open a new case. Therefore, it is to be understood that the examples and features described herein relate to particular users, and that levels of access preferably correspond to a user's predefined authorization.

After a user has submitted a valid user name and password, Options 400 are preferably presented that allow the authorized user to execute functions and use features associated with the present invention. For example and as illustrated in FIG. 4, Options 400 include Review Recently Completed Requests 402, View Reports 404, Action Required Reports 406, Create A New Case With Requests 408, Add/Edit/Delete Users 410, Enter New Request 411, Case Search 412 and View Case Bookmarks 414. Examples of View Reports 404 that are provided include Activity Report 416, Referral Report 418 and Accounting Report 420. Of course, one skilled in the art will recognize that many kinds of reports in addition to Reports 416, 418 and 420 can be provided herein to enable users to review information related to, for example, a medical-related lawsuit.

In addition to the Reports 416, 418 and 420 provided via Reports 404, the present invention preferably provides selected access to records in which various conditions have occurred that delay or prevent a request from being fulfilled. More particularly, Action Required Reports 406, when selected, provides a list of reports that are preferably available to a user and that effectively filter records to allow a user to access only those records that correspond with the action required. A discussion relating to choices available in accordance with Action Required 406 is provided below.

Continuing with reference to FIG. 4, a user preferably selects one or more choices from Options 400 in order to access and use many of the features described herein. For example, after selecting Recently Completed Requests 402, the user is presented a display screen of a list of providers, associated record types, completion dates and an indication whether comments are available. Many of the display screens provided by information processor 2 are formatted to include links to corresponding information and display screens. For example, after viewing a list of providers that is displayed after a user selects Recently Completed Requests 402, the entries in the list are preferably selectable, as known to those skilled in the art, to display additional corresponding information.

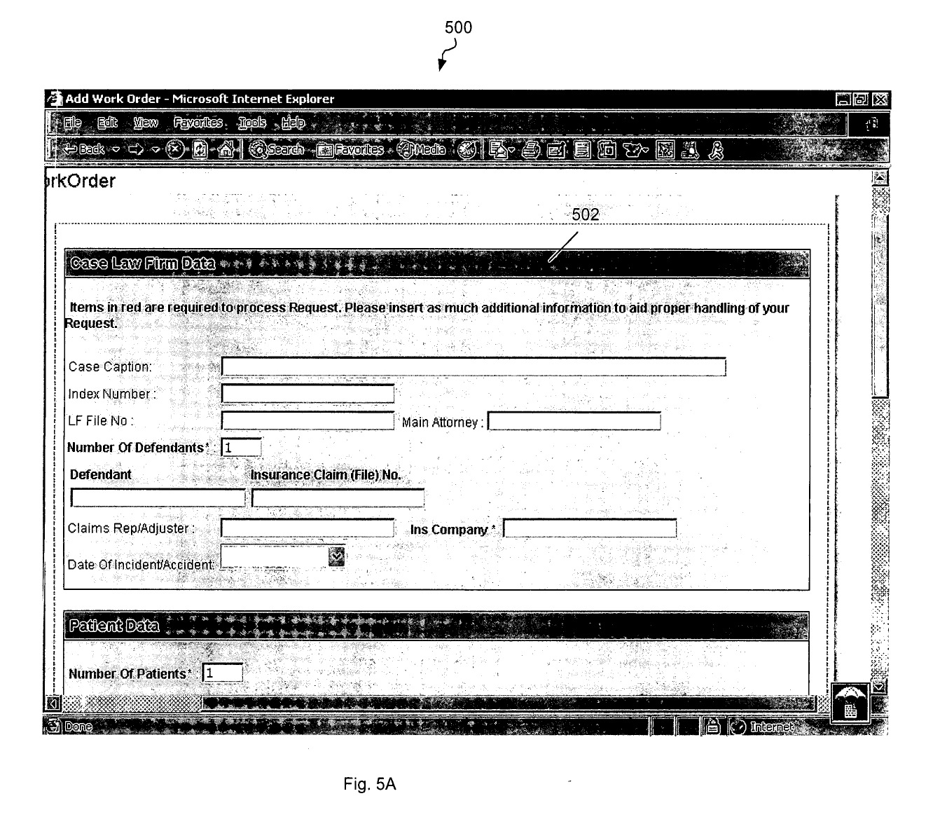

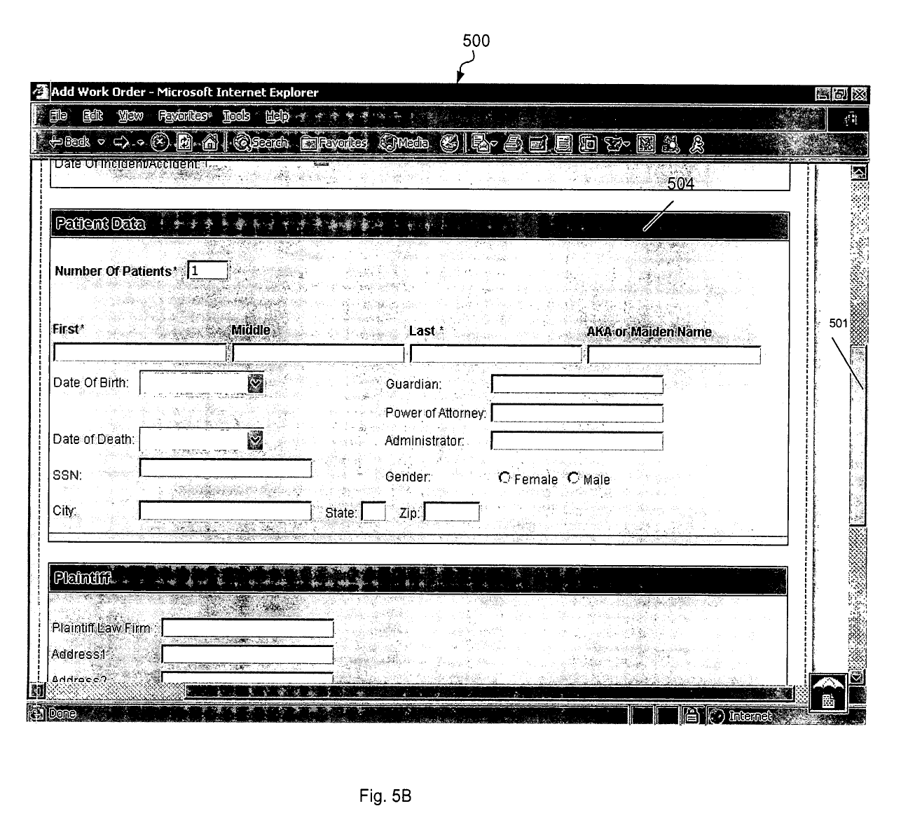

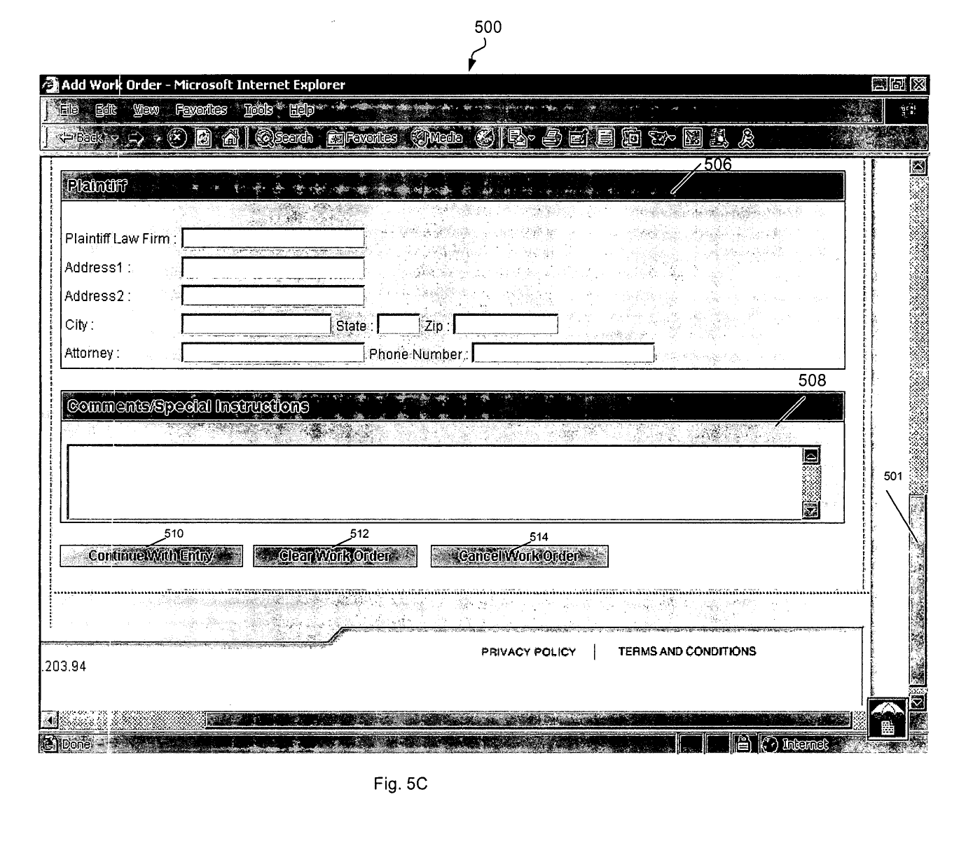

Steps and features associated with entering a new case are now provided with reference to FIGS. 5A-5C, and described by way of an example medical-related lawsuit.

An authorized user of the present invention enters information regarding a new case into a database managed by information processor 2. For example, after a defendant receives a summons, for example, related to a charge of medical malpractice, an authorized user enters the case in information processor 2. The user preferably accesses a user interface that includes selections corresponding with Options 400, and selects Create New Case With Requests 408 to access a data entry form and submit information regarding the case.

FIG. 5A illustrates a portion of data entry form 500 that is preferably displayed after a user selects Create New Case With Requests 408 from Options 400. In accordance with a preferred embodiment, many of the data items referred to in the art and herein, generally, as “data entry fields” are identified with an asterisk in data entry form 500 and are required. A user who attempts to process a new case will be unsuccessful if any of the required fields are left blank.

Continuing with reference to FIG. 5A, law firm data section 502 is used to submit information regarding and provided by a law firm. In law firm data section 502, the user preferably submits a case caption (e.g., “Jones v. Smith”), an index number which relates an indexing system particular to the respective law firm, a file number particular to the respective law firm, and an attorney name representing the lead or “main” attorney of the case. For example, the main attorney is a partner of a law firm handling the case. Also in section 502, the user enters the number of defendants in the case. As will become clear to one skilled in the art, the present invention is preferably dynamic in that virtually any number of defendants can be supported, with medical records, documents, and various other electronic health information of respective defendants being managed, requested and delivered to requesting parties in accordance with the teachings herein. Also in section 502, the user submits information representing an insurance claim or file number, a respective claims representative or adjuster, an insurance company name and a date of the incident/accident related to the particular lawsuit.

FIG. 5B illustrates patient data section 504 that is preferably provided in data entry form 500 after a user scrolls down, for example, via web browser scrollbar 501 from law firm data section 502. In patient data section 504, the user preferably enters information regarding patients, including the number of patients, the first name, middle name and last name of the patient(s), patient(s) date(s) of birth, guardian(s), power(s) of attorney, social security number(s), gender(s), city state and zip code.

FIG. 5C illustrates plaintiff data section 506 and comments/special instructions section 508 that are preferably provided in data entry form 500 after a user scrolls down, for example, via web browser scrollbar 501 from patient data section 504. In plaintiff data section 506, the user preferably submits the name, address, attorney and telephone number of the plaintiff's law firm. In comments/special instructions section 508, the user preferably submits any comments/special instructions with respect to the case. When the user is satisfied with the data entry, the user selects continue with entry control 510 to process the data entered in the form.

In case the user is not satisfied with the entries, the user selects either clear work order control 512, which erases all previous entries, but does not close the form 500, or cancel work order control 514, which erases the data entry and closes the form 500.

Thus, a user enters new case information via data entry form 500, and the data is preferably stored in database 8 for future use. As will become apparent to one skilled in the art, the ability to enter new case information in information processor 2 requires a relatively high degree of access by the user. Accordingly, many other users, such as those seeking to review whether a particular document has been distributed to a party, are not afforded the degree of access to the secured web site provided via information processor 2. The present invention is flexible to provide a range between minimum security allowing authorized users to access to virtually any respective area, and maximum security which severely restricts a user's access. A discussion regarding security and authorized access to features of the present invention is described in greater detail below.

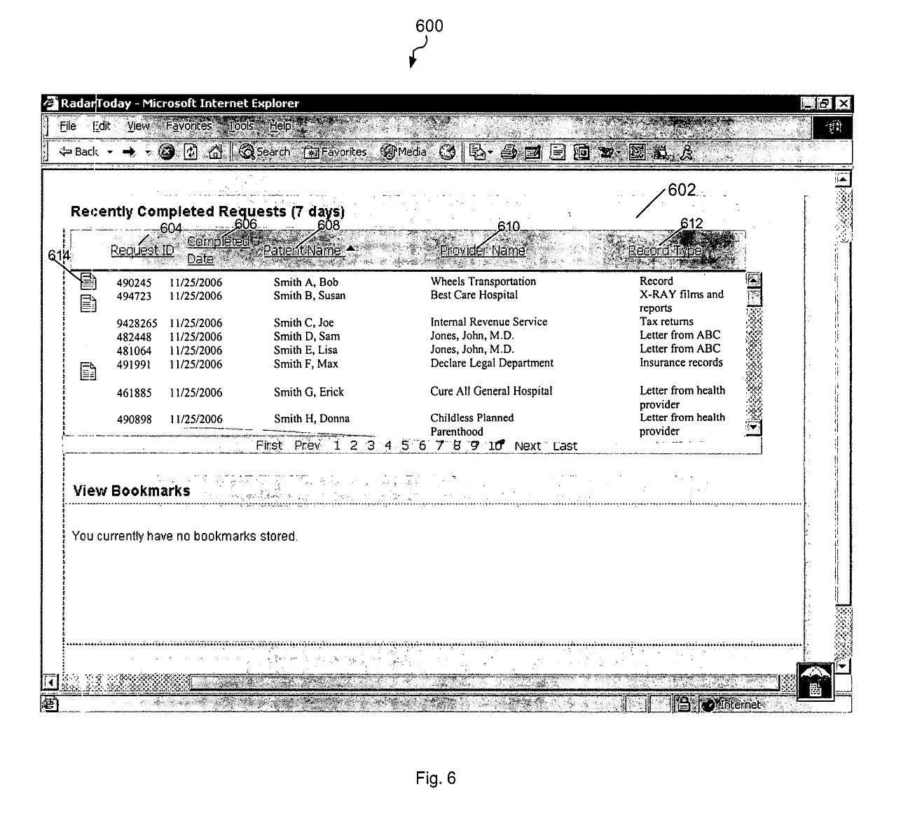

Once a case has been submitted into database 8, various requests related to the case are managed and performed in accordance with Options 400. FIG. 6 illustrates example display screen 600 that is presented after the option Review Recently Completed Requests 402 is selected from Options 400. As shown in FIG. 6, display screen 600 includes a list of recently completed requests. As used herein, a task refers to, generally, activity associated with receiving or requesting electronic information. For example, a request for X-RAY films and reports is a task. After the X-RAY film and report is delivered to the requesting party, the task is considered herein to be completed.

Continuing with reference to FIG. 6, display screen 600 includes completed requests section 602 that displays a list of information that, when selected, causes additional display screens to appear. In the example shown in FIG. 6, completed requests section 602 includes records representing a Request ID 604, Completed Date 606, Patient Name 608, Provider Name 610 and Record Type 612. Request ID 604 preferably represents an automatically generated, incremented value that functions as a unique index number in database 8. Completed date 606 represents the date that the respective task represented by Request ID 604 was completed. Patient Name 608 identifies the names of patients associated the completed requests. As shown in FIG. 6, adjacent to patient name 608 is an icon of a triangle that indicates that the names are sorted in ascending order. Preferably, the list in display screen 600 may be sorted by any of the columns in completed requests section 602 in ascending or descending order.

Continuing with reference to FIG. 6, provider name 610 identifies the respective health care provider 316 that provided the medical service associated with the record. Record type 612 identifies the kind of record provided. For example, letters, medical reports, X-RAYS or the like are listed under record type 612. Adjacent to some rows in completed requests section 602 is document icon 614 which represents that a particular document is viewable by the user. As noted above, the rows in completed requests section 602 are preferably formatted as links (e.g., hyperlinks) that, when selected, cause one or more additional display screens to be displayed. Document icon 614, when selected, indicates to the user that documents are available for viewing.

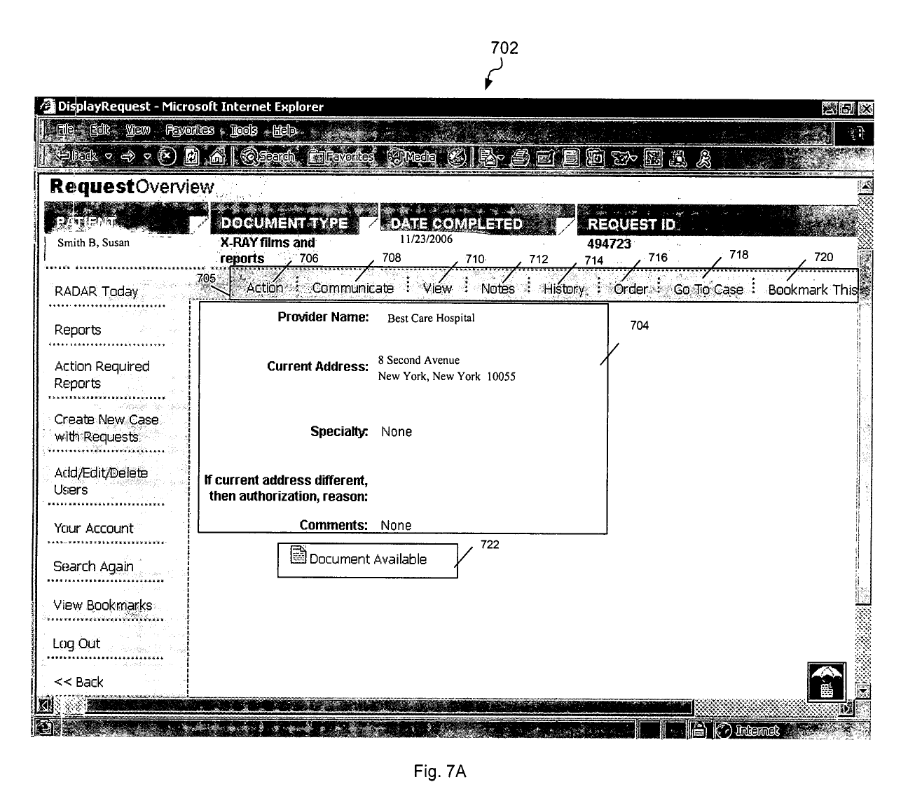

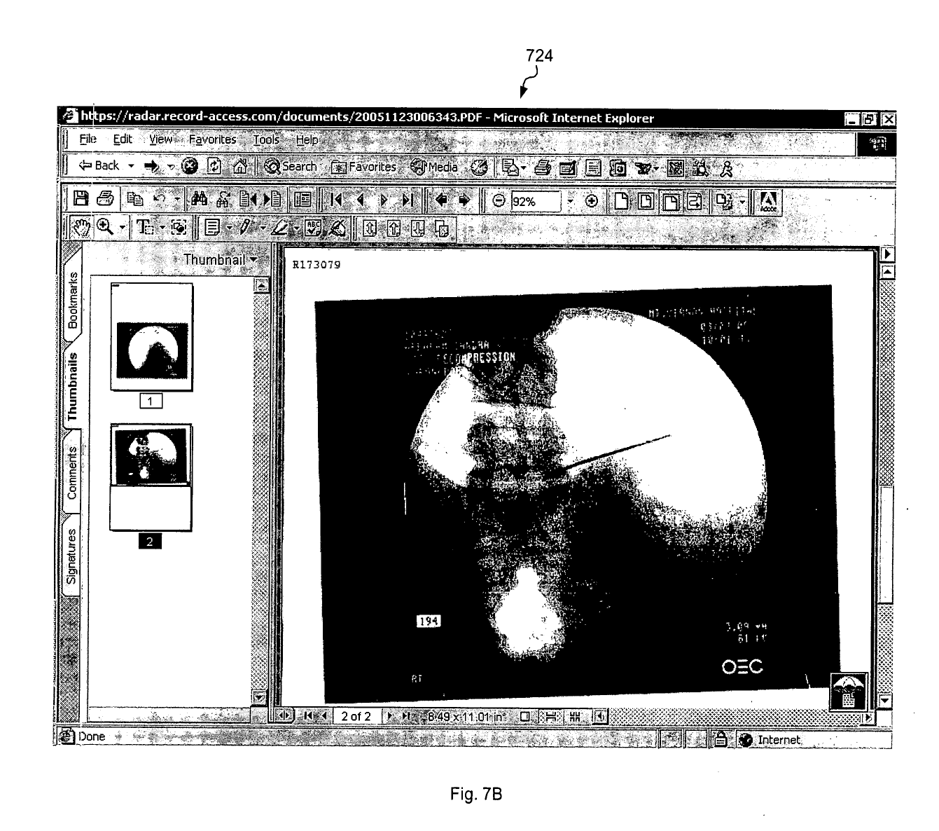

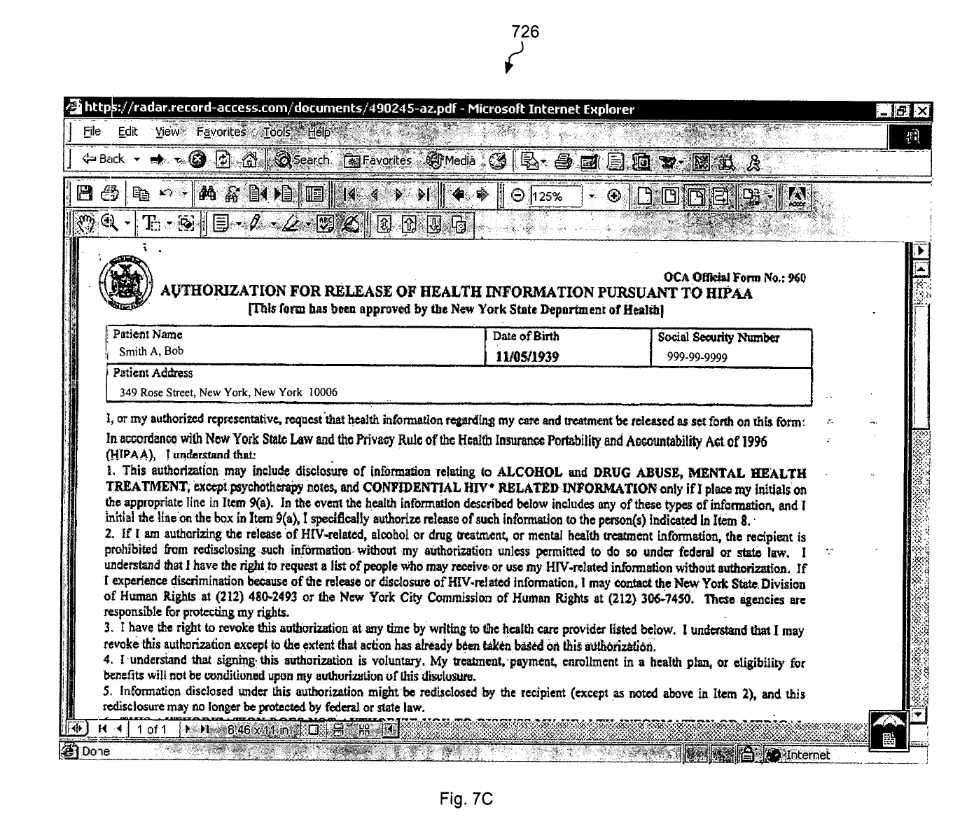

FIGS. 7A and 7B illustrate example display screens 702 and 724 that are provided to a user, for example, who selects a row in completed requests section 602. When a record is selected, request overview display screen 702 is preferably presented to the user that preferably includes provider information section 704. Request overview display screen 702 preferably identifies the respective patient, the respective document (if any), the date completed and the request ID that corresponds to the selected record in completed requests section 602. Provider information section 704 includes the name, address, specialty, and comments regarding the provider of the respective record corresponding to document icon 614. Also included in display screen 702 is control section 705 that includes a series of graphical screen controls that, when selected, allow the user to fulfill various requests associated with the request corresponding with the selected document icon 614.

In a preferred embodiment, control section 705 includes action control 706, communicate control 708, view control 710, notes control 712, history control 714, order control 716, go to case control 718 and bookmark control 720. Some of these controls appear in various other display screens provided by information processor 2, and, enable convenient navigation to various display screens. Action control 706 preferably enables the user to instruct information processor 2 to fulfill various requests with regard to the case, and/or parties associated with the selected record in completed requests section 602. For example, action control 706, when selected, allows the user to cancel a request, place a request on hold (e.g., temporarily suspending the request), or alert information processor 2 that the request must be rushed. Alternatively, action control 706 enables the user to remove a cancellation, remove a hold, or remove a rush.

Continuing with reference to control section 705, communicate control 708, when selected, preferably causes a data entry form to be displayed that enables the user to compose and send an e-mail message to a party. View control 710, when selected, allows the user to view information regarding the request. For example, view control 710 enables the user to select an original HIPAA compliant authorization request (referred to herein as “AZ”) that was transmitted to a healthcare provider 316. In another example, view control 710 enables a user to view a health care provider fee invoice. Notes control 712, when selected, preferably provides a data entry form that allows the user to compose and save a note. The note is preferably saved in database 8 and is available for future review. History control 714, when selected, displays a history of user access with respect to the current record. Preferably, the present invention tracks users, and proprietor 302 can, accordingly, monitor users and corresponding access dates and times for any record. By monitoring users and corresponding activity, the proprietor 302 has an opportunity to define various fee schedules to be charged to parties that interact with the present invention. For example, various business models can be fashioned by proprietor 302 that relate to a party's activity and/or use in accordance with system 10.

Order control 716, when selected, enables a user to order a copy of the record that is being viewed via request overview display screen 702. Preferably, users can order a printed copy of a record, or, alternatively, can request an electronic copy that is stored, for example, on CD-ROM. Go to Case control 718, when selected, preferably displays a display screen that lists all requests, completed or otherwise, that are associated with the case identified in request overview display screen 702. Bookmark control 720 allows the user to add a bookmark, as known to those skilled in the art, in order to simplify accessing the record in the future.

In addition to provider information section 704 and control section 705, request overview display screen 702 preferably includes document available icon 722 that, when selected, displays a requested document for the user. In a preferred embodiment, the documents are provided in a particular file format (e.g., ADOBE PORTABLE DOCUMENT FORMAT, “PDF”) and, when the user selects document available icon 702, the software application associated with the file format is automatically launched in the user's web browser software application. In the case of a PDF file, for example, when a user selects document available icon 722, ADOBE ACROBAT READER is automatically launched and the PDF file is displayed.

FIG. 7B illustrates an example document display screen 724 that displays a document after the user selects document available icon 722. In the example shown in FIG. 7B, the document is an X-RAY film. The user can review the document, print the document, save the document or perform other related tasks. FIG. 7C illustrates an example HIPAA compliant authorization request form that represents a properly formatted request for health information.

In accordance with the teachings herein, a user preferably operates the data entry display screens to request health information from a particular health provider, and the present invention ensures that proper formatting of the request occurs. As noted above, requests for health information, particularly with respect to HIPAA compliance, have technical formatting requirements which, if not adhered to, results in denials. Denials of health information can be extremely costly in terms of capital, time and resources. By centrally managing requests and ensuring proper compliance with formatting requirements, the present invention provides a substantial improvement over prior art methods of requesting, receiving and managing health information.

Thus, using various graphical screen controls, for example as illustrated in FIGS. 6 and 7A-7C, a user can review documents associated with a respective request or task.

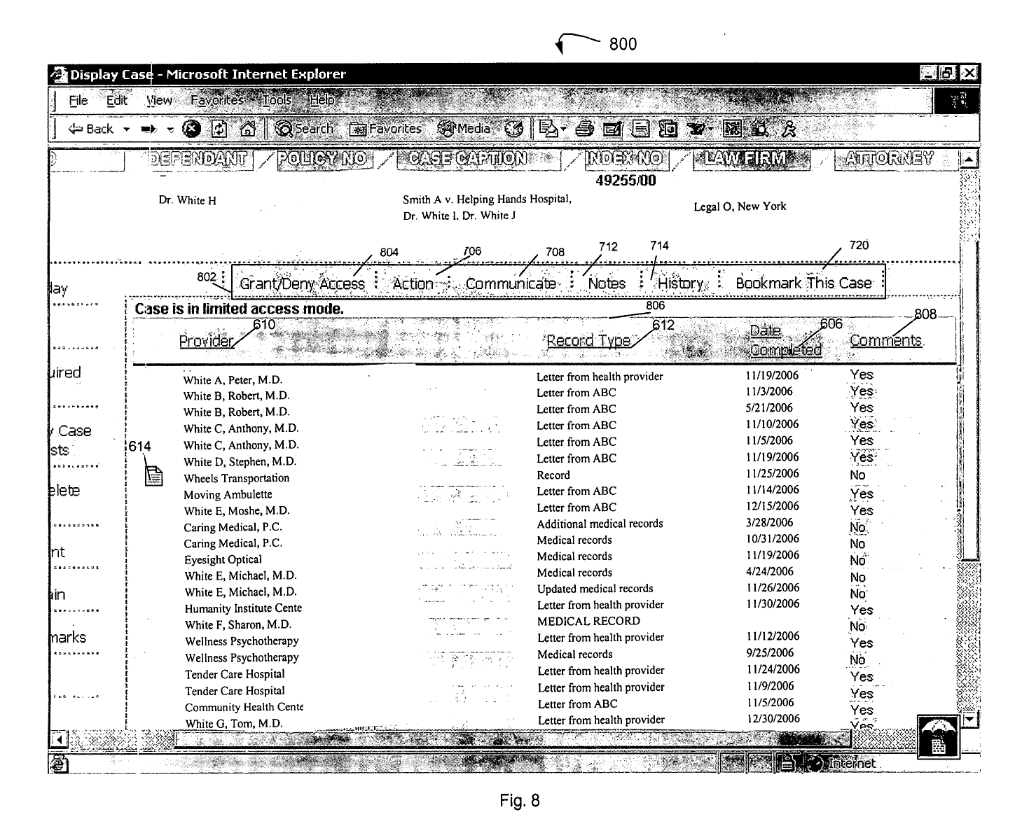

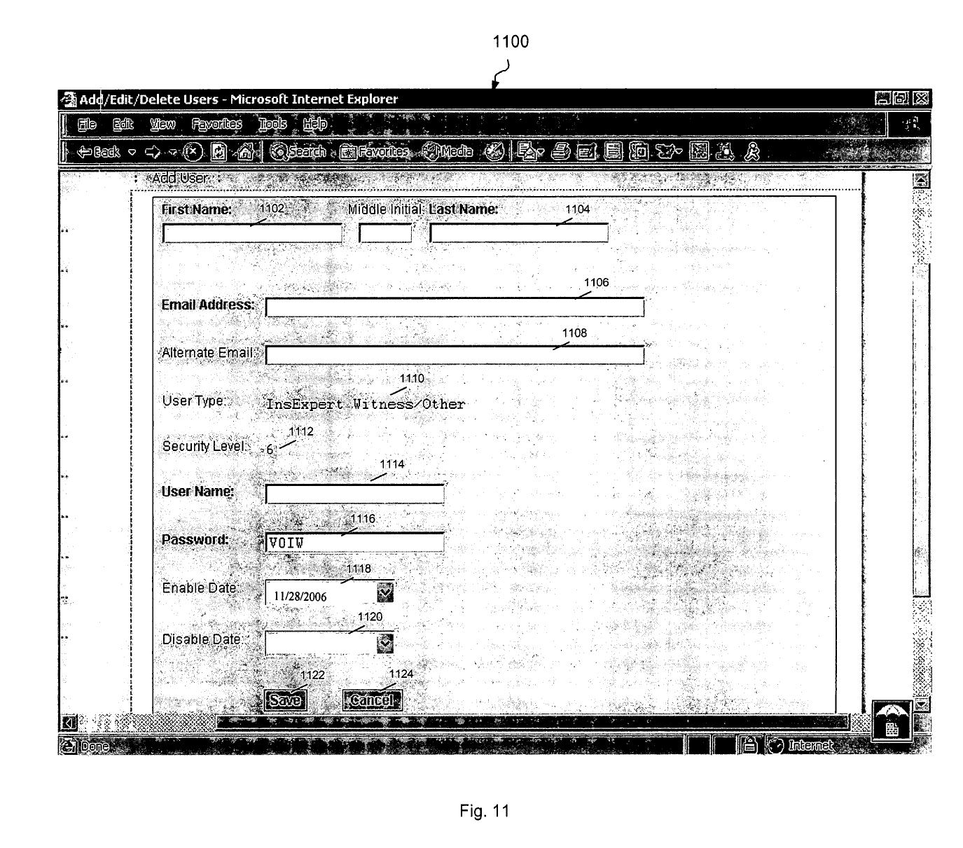

FIG. 8 illustrates an example case summary display screen 800 that is provided, for example, when a user selects go to case control 718. In a preferred embodiment, case summary display screen 800 has a dual use by two parties: an insurance company and a law firm. Each party may have a slightly different view of the particular legal action. For example, the insurance company may be able to view a claim number and document requests made by the participating law firm(s). On the other hand, Law firm(s) may be able to view the law firm file number, and only the requests made by that law firm. Thus, case summary display screen 800 provides respective views of information, depending at least in part upon the particular party viewing the screen. In the example shown in FIG. 8, case summary display screen 800 preferably provides the defendant's name, the insurance policy number, the index number, law firm and attorney that were previously entered (and described above with reference to FIGS. 5A-5C). Similar to request overview display screen 702, case summary display screen 800 preferably includes case summary control section 802 that includes many of the same graphical controls illustrated in control section 705. For example, summary control section 802 preferably includes action control 706, communicate control 708, notes control 712, history control 714 and bookmark control 720. In addition, summary control section 802 preferably includes grant/deny access control 804 that, when selected, enables a user to control access rights to information processor 2. A discussion regarding controlling a user's access rights is provided below with reference to FIG. 11.

Continuing with reference to FIG. 8, case summary display screen 800 preferably includes summary list section 806 that displays a list of providers 610, record types 612 and date completed 606. Further, comments 808 is preferably available to inform a user whether comments were previously submitted, for example, via Notes 712. Comments can, preferably, be reviewed by selecting a corresponding record in summary list section 806. Further, document icon 614 is preferably provided in any row in summary list section 806 in which one or more corresponding documents are available for review. As often the case, the rows in summary list section 806 are preferably selectable to enable information processor 2 to provide additional corresponding display screens. In a preferred embodiment, selecting a row in summary list section 806 results in request overview display screen 702 being displayed, thereby enabling the user to take corresponding actions, such as described above with reference to FIG. 7A.

In a preferred embodiment, the present invention provides several reports that assist users in managing document request workloads. Some reports preferably display information for a particular period of time that is selected by the user. Once the user runs such a report, the user preferably selects a row, as described above, to so-called “drill down” a respective line item to view additional information regarding a particular request. In addition to reports that contain selectable rows enabling a user to drill down to view additional information, some reports are preferably displayed that are static. These static reports, for example, Referral Report 418 and Accounting Report 420, display information for the user may contain selectable rows for limited use, such as for enabling access to request overview display screen 702. These reports can preferably be saved or printed by the user for future review.

Referring back to FIG. 4, Action Required Reports 422-436 are selectable and each preferably corresponds to an action that is required to fulfill a request. In the example shown in FIG. 4, Waiting For Information Report 422, Waiting For Fee Approval 424, Waiting For HIPAA AZ 426, Waiting For AZ, Pending Copy 430, Waiting For Letters Of Administration 432, Waiting For Prepayment 434 and Waiting For Special Release 436 all correspond to a request to be fulfilled.

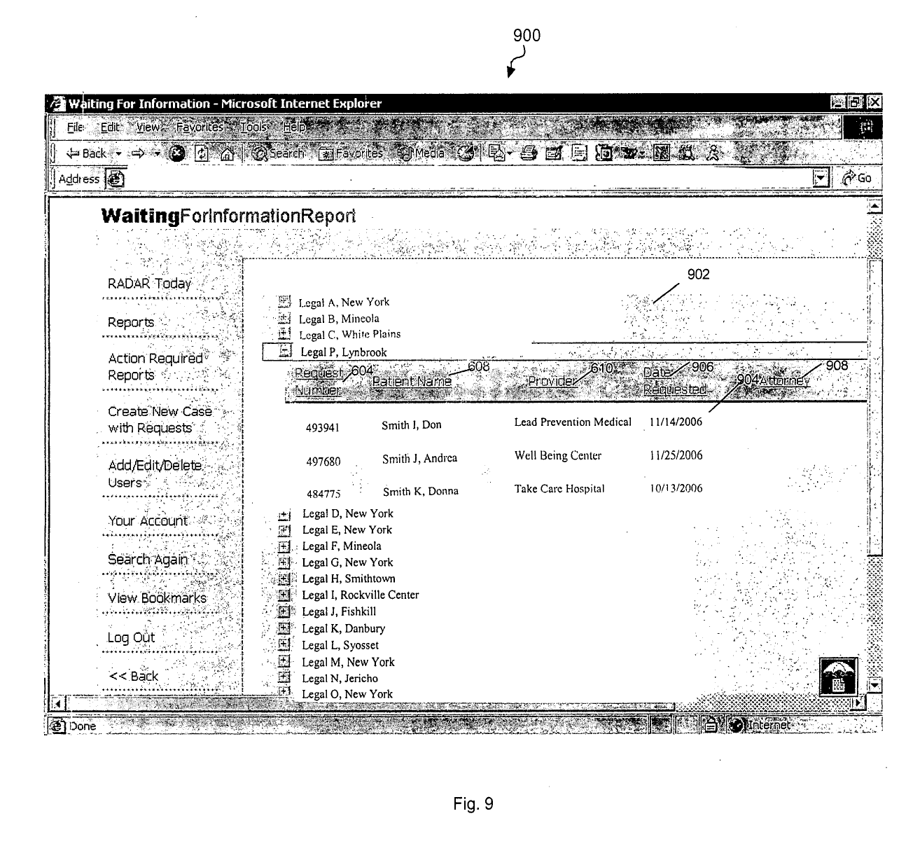

FIG. 9 is an example display screen that is preferably presented to a user after one of the Action Required Reports (i.e., waiting for information report 422) is selected. In the example shown in FIG. 9, a plurality of law firms are displayed. In a preferred embodiment, only parties with authorization' for viewing groupings of law firms, such as an insurance company, would have access to this view. In an alternative embodiment, such as in case a representative of a law firm is using the system, only that law firm's respective requests would display.

As shown in FIG. 9, law firms list 902 is preferably displayed that identify law firms that are involved in cases and in which a request is required and pending, thereby precluding fulfillment of the request. Further, the user has selected one particular law firm and, accordingly, requests list 904 is preferably displayed that shows requests corresponding with the respectively law firm. For example, requests list 904 preferably contains Request ID 604, Patient Name 608, Provider Name 610, Date Requested 906 and Attorney 908, which is preferably provided in Create New Case with Requests 408, and particularly in law firm data section 502. In a preferred embodiment, each row corresponding with requests list 904, when selected, displays request overview display screen 702 that corresponds with the selected row. Therefore, in accordance with a preferred embodiment, a user can filter for records that meet general criteria, such as waiting for information, and can thereafter use the drill down techniques described herein to view a specific record and take additional action. Each of the respective reports 422-436 preferably function in this way and relate to the respective actions that are required and incomplete.

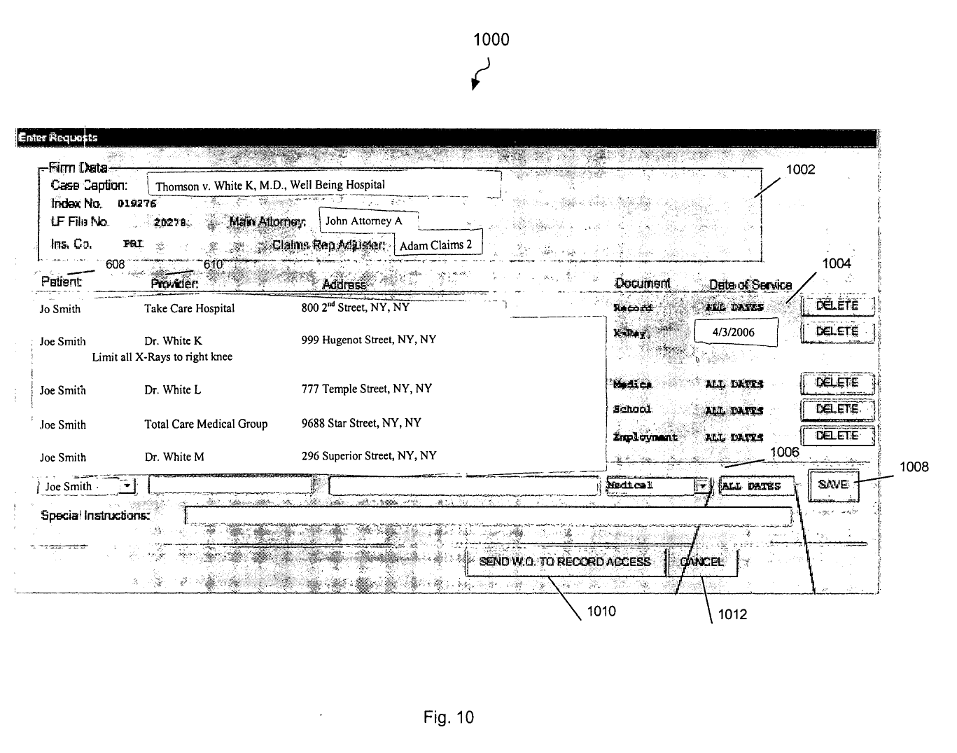

FIG. 10 illustrates an example enter requests display screen 1000 that is preferably provided to users requesting information, for example, following selection of Create New Request 411. In section 1002, display screen 1000 preferably displays information from law firm data section 502 the case caption, the index number, the law firm file number, the main attorney, the insurance company and claims representative/adjuster. Request section list 1004 displays a list of requests that have been added to the current work order during this session, and preferably includes the patient name 608, the provider 610, the document (or record type) 612 and the date of service. Adjacent to each row in list 1004 is preferably a graphical screen control that allows the user to delete a respective from the list 1004. In this way, in case a request is accidentally attached to the current work order, the user can preferably delete the request before the work order is submitted. Add new request section 1006 provides data entry fields that are used to submit information regarding new requests. For example, patient name, provider, address, document type and date of service are added by the requesting user to instruct information processor 2 to formulate, for example, electronic medical information in accordance with the teachings herein. Also provided is a data entry field for adding special instructions that may be necessary or pertinent. After the user is satisfied with the data entries, a graphical screen control, such as save button 1008 is preferably used to add the request. Preferably, the data appears in list 1004 once save button 1008 is selected. After the user is satisfied with the entries displayed in display screen 1000, the user preferably selects SEND W.O. TO Record Access control 1010 to process the request, or, alternatively, selects Cancel button 1012 to cancel the operation. Thus, using the options and graphical screen controls, such as illustrated in FIG. 10, a user can add a new request for, for example, electronic medical information.

FIG. 11 illustrates an example new user display screen 1100 that is preferably available for adding a new user to have access to the internet web site provided by information processor 2. Preferably, display screen 1100 is provided when a user selects add/edit/delete users 410. As shown in FIG. 11, data entry controls are provided for adding the new user's first name 1102, middle initial, last name 1104, e-mail address 1106, alternate e-mail 1108, user type 1110, security level 1112, user name 1114, password 1116, enable date 1118 and disable date 1120. The user further selects save button 1122 or cancel button 1124 to process the new user, or to cancel the operation, respectively.

In a preferred embodiment, user type 1110 represents a category of user, such as an expert witness. Further, security level 1112 represent a respective degree of authorization and corresponding privilege defined for a user. For example, a security level 1112 of one (“1”) may enable the newly added user to review case summary display screen 800, but not to select any screen controls in section 802. Alternatively, a security level 1112 of nine (“9”) may allow the newly added user to access each and every control and option provided by the present invention. Of course, one skilled in the art will recognize that various levels of security can be defined and/or modified. Enable date 1118 and disable date 1120 are preferably used to maintain a user's authorization to access various features of the present invention and defined herein.

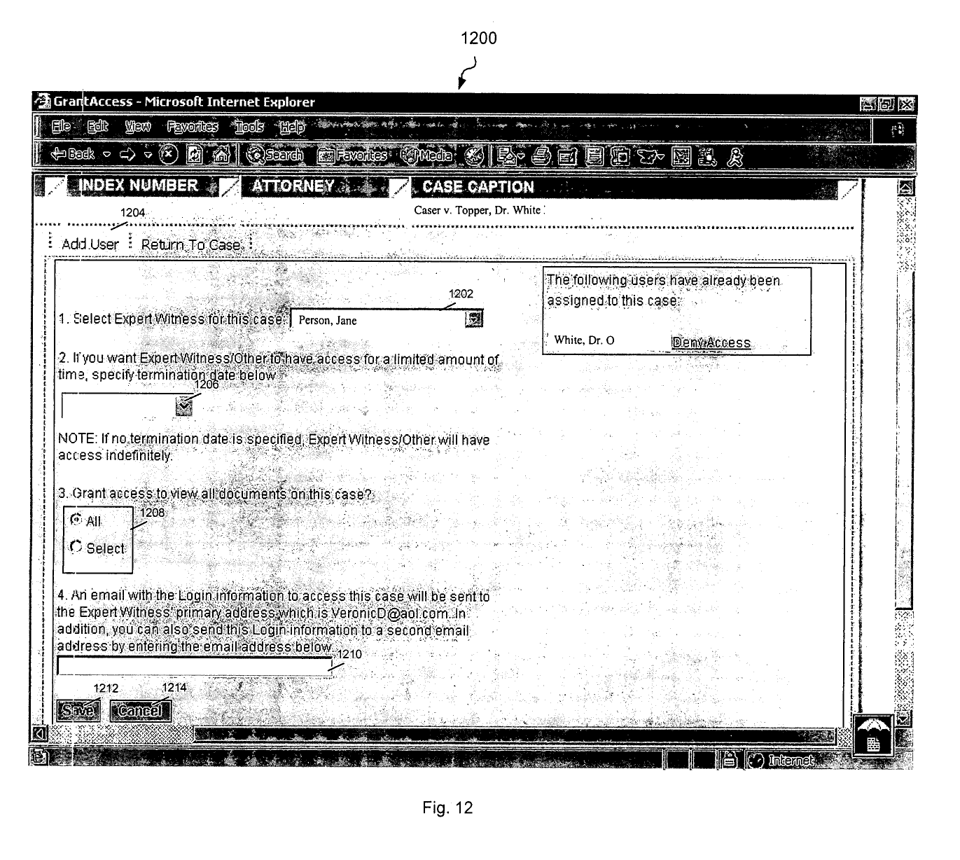

In addition to adding new users, the present invention preferably enables a user to add or select an expert witness for a respective case. FIG. 12 illustrates an example data entry display screen 1200 that is preferably provided to a user who is adding an expert witness for a case. In accordance with a preferred embodiment, expert witnesses are afforded access to the present invention in order to request, for example, electronic health information that relates to the case in which the witness is testifying. Expert witnesses are preferably assigned a user name 1114 and password 1116 that provides the expert with privileges to access data display and request screens, such as described herein.

An expert witnesses may also be assigned a control number that must be used when logging in to review requests for an individual case. This is an additional security feature provided to diminish the possibility of sharing a user name and password with an outside party who would then have access to all the cases to which the expert witness has been granted access.

As shown in FIG. 12, the user selects graphical screen control 1202 (illustrated as a drop-down list control) to select an expert witness. If a new expert witness is to be added, the user preferably selects Add User control 1204, and proceeds to add the expert, substantially as described above with reference to FIG. 11. Termination date graphical screen control 1206 allows the user to define a date when the expert will no longer have access to the invention. In grant access to view all documents control section 1208, the user restricts the expert witness's access to documents. The user submits an e-mail address that will be used by information processor 2 to transmit log in instructions to the expert witness. The user further selects save button 1212 or cancel button 1214 to process the new user, or to cancel the operation, respectively.

As noted above, an important feature of the present invention relates to security and access to the information provided by the present invention. When a new third party administrator 304, for example, solicits and contracts with proprietor 302, proprietor 302 ensures that only authorized users and respective parties can access data and information described herein. One of the security checks provided by the present invention relates to checking each user's IP address. As known to those skilled in the art, the user IP is a unique number that is assigned by the user's internet service provider. Proprietor 302 has the option to limit a user's access to the internet web site provided by information processor 2 from computers that are located on-site at the third party administrator's 304 office. Information processor 2 preferably captures the user's IP address, and then compares it to a stored value in database 8. If there is a match with the IP address, then the user is allowed access.

In a preferred embodiment the present invention allows for up to six different on-site IP addresses, or three different IP address ranges. Most third party administrators use a single IP address, even if there are multiple computers on a network. Typically, there is one shared router and this router has the IP address that is stored in database 8. Alternatively, a third party administrator may have a connection to the internet that uses dynamic IP addresses, or a company may have multiple sites or use multiple routers. The present invention is preferably designed to handle such cases. For example, in case a single router is shared on a network, the router's outside IP address is stored in database 8. If multiple routers use the same subnet, then the starting IP address and ending IP address for client computing devices is preferably stored in database 8. Preferably, the present invention supports up to three different subnet pairs. In case of multiple routers on different subnets or different locations, individual IP addresses (e.g., up to six) are preferably stored in database 8. Further, in case a dynamic IP connection is used, then a starting IP address and ending IP address, representing a range of IP addresses is preferably stored.

Other security options that are preferably configurable by proprietor 302 include setting a default time-out value, and defining security level privileges. Other features, such as described above with reference to FIG. 11, are provided and include a date range for authorized use, and restricting a user's access to a particular case.

Other security features known in the art are envisioned herein. For example, the present invention preferably provides secured communication sessions with users that employ one or more encryption protocols.

In addition to maintaining security, the present invention preferably includes data utilities, such as to transform data from one format to another. Preferably, the present invention utilizes file transfer protocol (“FTP”) and various data extraction routines in order to efficiently transmit and store data. Data archival mechanisms are further employed in order to efficiently store data, for example, during and after a law suit.

Moreover, proprietor 302 preferably trains third party administrators 304 or other users to ensure accurate and fluent use of the present invention. By properly training various personnel, proprietor 302 can rely on the security and usefulness of the sensitive information that is transmitted and received by various parties.

Thus, as described herein, the present invention comprises a centrally managed system that processes, formats and transmits requests for information, including documents and records related to medical care provided to a patient. The invention ensures properly formatted requests in accordance with various HIPAA or other requirements. Furthermore, the present invention assures a process of regular follow-up to such requests to ensure that electronic information is received. In case of a denial, reasons for the denial are quickly pursued and, when possible, remedied. Parties requesting the documents, such as law firms representing defendants, who are authorized to access such materials are provided the materials in a timely and cost effective manner. Thus, the present invention dramatically improves upon prior art methods of requesting and providing electronic information.

The present invention is now further described by way of an example.

A physician is served a summons in civil litigation. The physician is being sued for malpractice related to medical care that was provided to a plaintiff four years earlier, however the plaintiff's symptoms have only recently appeared. The physician treated the patient at a hospital, and, following treatment, referred the patient to a physical therapist for follow up therapy. The physician has malpractice insurance with a well-known provider, and contacts his provider immediately upon being served. The physician also contacts his personal attorney.

The insurance provider is a contracting member with proprietor 302 of the present invention. An authorized user of the insurance provider logs into information processor 2 and selects create new case 408. The user submits information regarding case law firm data 502, patient data 504, and the plaintiff 506, and saves the record. Thereafter, the user selects enter new request 411 and requests all medical records maintained at the hospital relating to the patient from one year prior the treatment to the present. The user enters a request for medical records maintained by the physical therapist. The physical therapist relocated his office three times over the past four years. Using the annotated and notes feature of the present invention, the user is informed of each respective relocation, typically during a later time during the process, and has the correct demographic information for processing the request. Thereafter, the user logs out of information processor 2.

Using the automated functions of the present invention, all of the requests submitted by the user are properly formatted in accordance with HIPAA, and the requests are transmitted to the hospital and the physical therapist. The hospital and the physical therapist receive the requests, and proceed to retrieve the relevant documents. The documents are sent via courier to the proprietor of the present invention, and are scanned and converted to ADOBE PDF files. The user of the present invention receives an e-mail message indicating that the documents are available. The user logs into information processor 2, selects Recently Completed Requests 402, and navigates to the electronic documents.

From the time that the request for the documents was made, the physician's attorney hired an expert witness who asked to review the medical records. Another authorized user of the present invention, an administrator at the attorney's law firm, selects the add/edit/users 410 and selects the expert witness to have access to the medical records via information processor 2. The administrative user selects a termination date, in which the expert witness will no longer have access to information processor 2. Thereafter, the expert witness logs into the system, and reviews the medical records. The expert witness determines by the medical records that the physician did not cause the plaintiff's injury. Accordingly, at trial, the expert testifies and the physician is held to be not liable.

Thus, as described with reference to the above example, the present invention enables parties to have access to electronic materials quickly and conveniently. The present invention provided a substantial cost savings resulting from the timely and secure transmission of sensitive information.

Although many of the examples and descriptions used herein refer to a single medical lawsuit and a single defendant, the invention is not so limited. For example, the present invention supports complex arrangements regarding, for example, a plurality of defendants, a plurality of patients and a plurality of lawsuits. For example, a single third party administrator may require documents for a plurality of pending lawsuits for respective defendants. Each defendant may have a plurality of law firms working on a respective case. Furthermore, each respective plaintiffs in a plurality of lawsuits may have a plurality of healthcare providers 316. In accordance with the security standards implemented by the present invention, for example, as described above, information is properly channeled to correct parties. Thus, extremely complex arrangements of parties, including plaintiffs, defendants, healthcare providers, law firms, expert witnesses, or the like all interact with proprietor 302 in an organized and efficient way.

Other uses and products provided by the present invention will be apparent to those skilled in the art. Although the present invention has been described in relation to particular embodiments thereof, many other variations and modifications and other uses will become apparent to those skilled in the art. It is preferred, therefore, that the present invention not be limited by the specific disclosure herein.

1. A system for facilitating requests for information related to at least one party in a lawsuit, the system comprising:
a request form module that is operable to store on an information processor a information request form, wherein the form is usable to request information and further wherein the form complies with at least one regulation;
a service provider module that is operable to store on the information processor information relating to a service provider;
a lawsuit module that is operable to store on the information processor lawsuit information relating to the lawsuit;
a request module operable to store on the information processor request information that relates to requests for information;
an information module that is operable to store on the information processor electronic information received in response to the request for information; and
a user interface module that is operable to provide a user interface that enables a user to perform at least one of:
requesting and receiving the request form;
entering and viewing the request information;
entering and viewing status information regarding the information request;
entering and viewing the lawsuit information; and
entering and viewing the information;
wherein the request form module, service provider module, lawsuit module, request module, and information module are operable to receive information as a function of the user interface over a communication network, such that requests for information can be facilitated.

2. The system of claim 1, wherein the information relates to health information, the service providers are healthcare providers, and further wherein the user interface provides a list of selectable hyperlinks directed to at least one of a plurality of requests for health information, a plurality of lawsuits, a plurality of patients, a plurality of healthcare providers, a plurality of law firms, a plurality of insurance companies and further wherein the interface displays details that correspond to a respective selected hyperlink.

3. The system of claim 1,further comprising a user access module that is operable to enable a user to control a level of access to modules on the information processor that another user can have.

4. The system of claim 1, further comprising a law firm module that is operable to store on the information processor law firm information relating to a law firm.

5. The system of claim 4, wherein the law firm information includes information representing an individual who is a partner in a law firm, an individual who is employed by a law firm or an individual who is contracted by a law firm.

6. The system of claim 1, further comprising an update module that is operable to update information stored on the information processor.

7. The system of claim 1, further comprising an insurance company module that is operable to store on the information processor insurance company information relating to an insurance company.

8. The system of claim 7, wherein the insurance company information includes information representing an insurance policy, an individual who is employed by an insurance company or an individual who is contracted by an insurance company.

9. The system of claim 1, further comprising a request tracking module that is operable to monitor the fulfillment of a request for information and to alert a user to a status of the request.

10. The system of claim 9, wherein the status represents at least one of an amount of time that has passed since a request for information was made, whether a request was received or acknowledged, and other request information entered by a user.

11. The system of claim 1, further comprising an internet web site that includes the user interface module.

12. The system of claim 1, wherein the information processor includes at least one computing device.

13. A method for facilitating requests for information related to at least one party in a lawsuit, the method comprising:
storing on an information processor electronic an information request form, wherein the form is usable to request information and further wherein the form complies with at least one regulation;
storing on the information processor service provider information relating to a service provider;
storing on the information processor lawsuit information relating to the lawsuit;
storing on the information processor request information that relates to requests for information;
storing on the information processor information received in response to the request; and
providing a user interface that enables a user to perform at least one of:
requesting and receiving the request form;
entering and viewing the request information;
entering and viewing status information regarding the request;
entering and viewing the lawsuit information; and
entering and viewing the information;
wherein the electronic information request form, service provider information, lawsuit information, request information and information are provided and received as a function of the user interface over a communication network such that requests for information can be facilitated.

14. The method of claim 13, wherein the information relates to health information, the service providers are healthcare providers, and further wherein the user interface provides a list of selectable hyperlinks directed to at least one of a plurality of requests, a plurality of lawsuits, a plurality of patients, a plurality of healthcare providers, a plurality of law firms and a plurality of insurance companies, and further wherein the interface displays details that correspond to a respective selected hyperlink.

15. The method of claim 13, wherein the user interface enables a user to control a level of access to modules on the information processor that another user can have.

16. The method of claim 13, further storing on the information processor law firm information relating to a law firm.

17. The method of claim 16, wherein the law firm information includes information representing an individual who is a partner in a law firm, an individual who is employed by a law firm or an individual who is contracted by a law firm.

18. The method of claim 16, further comprising updating information stored on the information processor as a function of the user interface.

19. The method of claim 13, further comprising storing on the information processor insurance company information relating to an insurance company.

20. The system of claim 19, wherein the insurance company information includes information representing an insurance policy, an individual who is employed by an insurance company or an individual who is contracted by an insurance company.

21. The method of claim 13, further comprising monitoring the fulfillment of a request for health information and alerting a user to a status of the request.

22. The method of claim 21, wherein the status represents at least one of an amount of time that has passed since a request for health information was made, whether a request was received or acknowledged, and related request information entered by a user.

23. The method of claim 13, further comprising providing an internet web site that includes the user interface.

24. The method of claim 13, wherein the information processor includes at least one computing device.

25. The system of claim 1, wherein the information relates to healthcare, and the service providers are healthcare providers.

26. The method of claim 13, wherein the information relates to healthcare, and the service providers are healthcare providers.
